(19) United States
(12) Patent Application Publication
(10) Pub. No.: US 2018/0209866 A1
(43) Pub. Date: Jul. 26, 2018

(54) RECONFIGURATION OF AIRCRAFT

(71) Applicant: AIRBUS OPERATIONS GMBH, Hamburg (DE)

(72) Inventors: Johannes GONNSEN, Hamburg (DE); Frank-James-Edmund RODFORD, Hamburg (DE); Sven-Agustin LANZAN-FERRAN, Hamburg (DE)

(21) Appl. No.: 15/926,707

(22) Filed: Mar. 20, 2018

Related U.S. Application Data
(63) Continuation of application No. PCT/EP2016/074024, filed on Oct. 7, 2016.

(30) Foreign Application Priority Data
Oct. 7, 2015 (DE) 102015117110.4

(51) Int. Cl. G01M 1/12; B64D 9/00; B64D 11/04; B64D 11/02; B64D 11/06; G06F 17/50

(52) U.S. Cl. CPC G01M 1/127; B64D 9/00; G06F 17/5095; B64D 11/02; B64D 11/06; B64D 11/04

(57) ABSTRACT

An aircraft reconfigurator system reconfigures a predetermined aircraft configuration, in particular a cabin layout, for which a distance between a position of a center of gravity of the aircraft, the center of gravity being optimized with respect to aerodynamic characteristics, and the actual position of the center of gravity is determined and thereupon an element of the aircraft is selectively displaced such that the position of the center of gravity is approximated to the optimized position of the center of gravity. Afterwards, a new aircraft configuration, in which the selected element is arranged in the new position, is determined. By means of the reconfiguration of the aircraft it is possible to save fuel.

### CROSS-REFERENCE TO PRIORITY APPLICATIONS

This application is a continuation of international patent application number PCT/EP2016/074024, having an international filing date of Oct. 7, 2016, which claims priority to German patent application number DE 102015117110.4, having a filing date of Oct. 7, 2015. The content of the referenced applications is incorporated by reference herein.

### TECHNICAL FIELD

Embodiments of the subject matter described herein relate generally to the reconfiguration of aircraft. In particular, embodiments of the invention relate to an aircraft reconfigurator for reconfiguring a predetermined aircraft configuration, a booking system for an airline, a method for reconfiguring a predetermined aircraft configuration, a program element, and a computer readable medium.

### BACKGROUND

For increasing the efficiency of the operation of aircraft, various measures may be taken. For example, it is possible to use more efficient aircraft engines which are characterized by reduced fuel consumption. Modified wing profiles and fuselage shapes may be used as well in order to improve the drag of the aircraft and its lift characteristics. For specific applications, it may prove useful to provide so called winglets at the ends of the wings, which winglets improve the aerodynamic characteristics of the airplane.

### BRIEF SUMMARY

It is an object of the disclosure to further improve the efficiency of aircraft.

This object is solved by the subject matters of the independent claims. Further developments of the disclosure can be derived from the dependent claims and from the following description.

According to an aspect of the disclosure, an aircraft reconfigurator is provided, which aircraft reconfigurator is a device for reconfiguring, i.e., changing, a predetermined aircraft configuration. The aircraft reconfigurator comprises a processing unit which can determine a distance between a position of the center of gravity of the aircraft which center of gravity is optimized with regard to aerodynamic (and/or other) aspects or which is at least very favorable and the actual position of the center of gravity or the position to be expected for the next flight.

The optimized position of the center of gravity is a position of the center of gravity which would prove favorable for the forthcoming operation of the aircraft with regard to the fuel consumption. In particular, this position depends on the aerodynamic characteristics of the aircraft and varies from one aircraft type to another. The position of the optimized center of gravity may as well be dependent on the flying weight of the aircraft.

In the aircraft reconfigurator, there may exist a table, for example, from which the optimal position of the center of gravity for each aircraft type and different take-off weights emanates.

The actual position of the center of gravity is the position of the center of gravity when meeting the boundary conditions instant at the processing unit, i.e. in particular aircraft type, weight, and weight distribution. In particular, the planned distribution of cargo and passengers in the airplane may be taken into account, too.

This actual position of the center of gravity is determined by the processing unit or already exists in advance as well. Thereupon, the processing unit may select one or multiple elements of the aircraft and may determine their position in the aircraft. One or multiple of these positions can then be modified by the processing unit with the objective to approximate the position of the center of gravity to the optimized position of the center of gravity. Thereupon, the processing unit may calculate a new aircraft configuration in which the selected element or the selected elements is/are located in the new position or positions, respectively.

Hence, multiple elements of the aircraft may be identified which are to be moved or swapped as to approximate the position of the center of gravity the optimized position of the center of gravity. Thereupon, a new aircraft configuration is determined in which the selected elements are located at new positions. By means of the reconfiguration of the aircraft it is possible to save fuel. The same applies to a planned airplane layout which may be optimized with respect to fuel consumption.

At this point, it should be noted that the reconfigurator must consider a huge amount of boundary conditions when determining the new aircraft configuration. For example, moving an installation in the aircraft cabin typically results in moving other installations. As a general rule, it is not possible here to move a specific installation to any desired position. Rather, only a limited number of positions is possible for each installation.

The various positions of all elements of the aircraft, which elements are eligible for such a moving, and the boundary conditions coming along therewith, may be described by a description logic, for example.

As a result of moving the actual center of gravity of the aircraft towards an optimized position of the center of gravity, it is possible to save fuel during operation of the aircraft. Moving the center of gravity a few centimeters may lead to a significant effect already.

The “configuration” of the aircraft defines, for example, the position of all or at least selected elements of the aircraft, in particular of the monuments and system components being arranged in the cabin, but also the arrangement of primary and secondary structural components like frames or stringers, where applicable.

For example, the aircraft reconfigurator may be configured to shift (reposition, displace, move) a multitude of these elements as to optimize the position of the center of gravity. However, it may also be provided that the reconfigurator considers only elements of the airplane cabin which may be shifted within the scope of a (standard) reconfiguration between two operations of the aircraft. For such a reconfiguration, multiple days, multiple hours, or, in extreme cases, merely a few minutes may be provided. In the latter case, the elements may be passenger seats and rapidly shiftable monuments, as well as passengers and cargo.

According to an embodiment of the invention, the aircraft reconfigurator comprises an input unit for predetermining (i.e., inputting) of loading data of the aircraft, which loading data reflect the weight, the position, and the kind of cargo (goods, packages) to be transported. The processing unit is configured to consider the cargo as elements of the aircraft, too, and to determine the actual position of the center of gravity in consideration of the loading data.

For example, if it is defined how many cargo pieces are to be transported with the next flight and the respective weight of the cargo pieces, the processing unit may create a loading plan which contains the loading position of individual or all cargo pieces. Thus, it is possible, for example, to position very heavy or very light cargo pieces at advantageous positions in the cargo space as to approximate the position of the center of gravity of the aircraft as close as possible to the optimal position of the center of gravity prior to take-off

According to a further embodiment of the invention, an input unit is provided which is configured for inputting passenger data of the aircraft. This may be the same input unit which is already described above or a different input unit. These passenger data reflect the number and possibly also the weight of the passengers to be transported. The processing unit is configured to consider also these passengers as elements of the aircraft and to determine the actual position of the center of gravity in consideration of the passenger data.

As a final result of the reconfiguration, a new allocation plan (seating plan) of the passenger cabin may be generated, for example. In other words, it is possible that during the reconfiguration specific passengers are assigned another seat, for example a seat further towards the tail of the aircraft.

According to a further embodiment of the invention, the aircraft reconfigurator may also be configured to shift not only the position of one or multiple elements of the aircraft, but to replace various elements with other elements as to modify the position of the center of gravity and to approximate it to the optimized position of the center of gravity. For example, it may be possible that the aircraft reconfigurator proposes using another galley and/or position of the galley for the new aircraft configuration in comparison to the initial plan.

According to a further embodiment of the invention, the selected element is a monument of an aircraft cabin, for example a galley or a lavatory module, a system component, a consumer, for example an electric consumer, a passenger seat, or a structural component of the aircraft.

The element may be a trolley as well. Fully laden trolleys may have a significant weight and it may be provided that the system outputs a trolley loading plan which indicates where to park which trolley prior to take-off. The parking positions may vary—depending on the flight mission and the loading condition of the aircraft.

According to a further embodiment of the invention, the reconfigurator comprises an input unit for changing the new position of the element of the aircraft after the processing unit has already determined the new aircraft configuration. This may make sense if an operator does not agree to the new position of the element. Thereupon, the processing unit may select a further element of the aircraft and to subsequently determine a new position of the further element as to approximate the position of the center of gravity to the optimized position.

According to a further embodiment of the invention, the processing unit is configured to determine a probable average fuel saving related to the new position of the element of the aircraft and, hence, the new aircraft configuration. The fuel saving may be related to the next mission of the aircraft, for example.

Subsequently, the operator may decide if he/she agrees to the new configuration or not.

According to a further aspect of the disclosure, a booking system for an airline or another service institution is provided, which booking system comprises the aircraft reconfigurator described above and hereinafter. Hence, this booking system is able to adapt the distribution of the passengers and the cargo in the aircraft such that the center of gravity of the aircraft shifts towards the optimized center of gravity.

Starting point for this determination of the shifting of the center of gravity may be a random distribution of the cargo and the distribution (allocation) to the seats desired by the individual passengers. Based on the determination described above, the booking system may output a new seat allocation and the preferred loading position of specific cargo pieces.

According to another aspect of the disclosure, a method for reconfiguring a predetermined aircraft configuration is provided which enables reducing a distance between a position of the center of gravity of the aircraft which position is being optimized with regard to aerodynamic aspects, and the actual position of the center of gravity. Thereupon, one or multiple elements of the aircraft are selected and determination of a new position of the element of the aircraft takes place as to approximate the position of the center of gravity to the optimized position. Afterwards, determination of a new aircraft configuration takes place, in which the selected element is arranged in the new position.

A further aspect of the disclosure relates to a program element which instructs a processor of a processing unit to carry out the steps described above and hereinafter when being carried out on the processor.

The program element may be, for example, part of a software which is stored on a processor of the reconfigurator. The processor may likewise be an embodiment of the invention. Furthermore, this exemplary embodiment of the invention comprises a computer program element which uses the disclosed methodology right from the start, as well as a computer program element which initiates an existing program for using the methodology by an actualization (update).

A further aspect of the disclosure relates to a computer readable medium on which the program element described above is stored.

In the following, exemplary embodiments of the invention are described with reference to the drawings. If in the following description of the drawings similar reference signs are used, these indicate equal or similar elements.

his summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 shows an aircraft which may be newly configured by means of an aircraft reconfigurator.

FIG. 2 shows a booking system with an aircraft reconfigurator according to an exemplary embodiment of the invention.

FIG. 3 shows possible positions of elements of an aircraft.

FIG. 4 shows other possible positions of elements of an aircraft.

FIG. 5 shows a flow chart of a method according to an exemplary embodiment of the invention.

FIG. 6 shows possible shifts of the actual position of the center of gravity of an aircraft according to an exemplary embodiment of the invention.

The representations in the drawings are schematic and not to scale.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

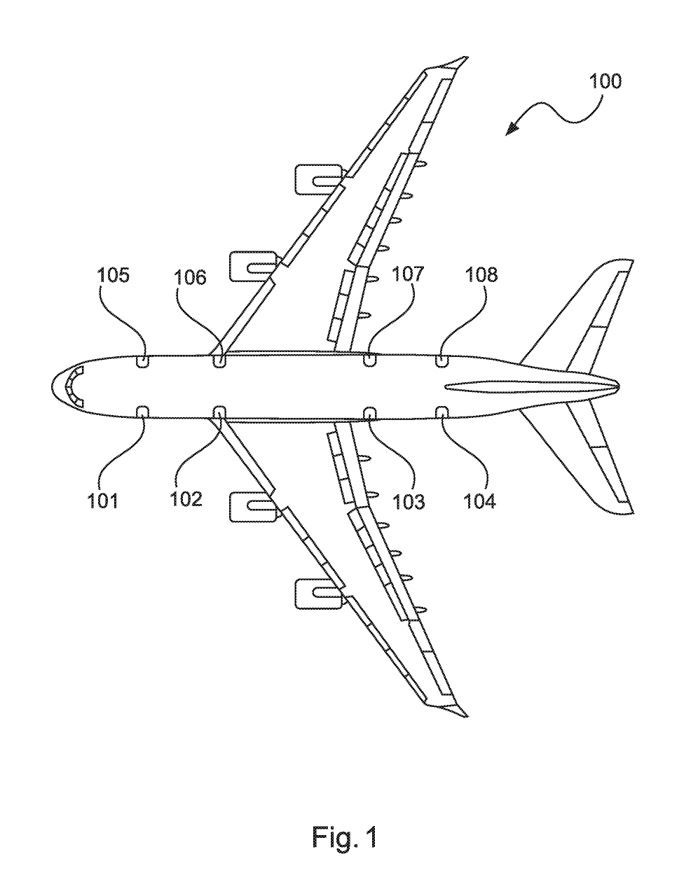

FIG. 1 shows an aircraft 100 which can be newly configured (reconfigured) by means of an aircraft reconfigurator. When referring to reconfiguration, this is in particular to be understood as shift or displacement of cabin elements of the aircraft cabin, which may happen, for example, between two missions of the aircraft. The aircraft comprises a plurality of doors, wherein the doors 101, 105 are indicated as doors 1, the doors 102, 106 arranged behind are indicated as doors 2, the doors 103, 107 arranged behind are indicated as doors 3, and the most rear doors 104, 108 are indicated as doors 4.

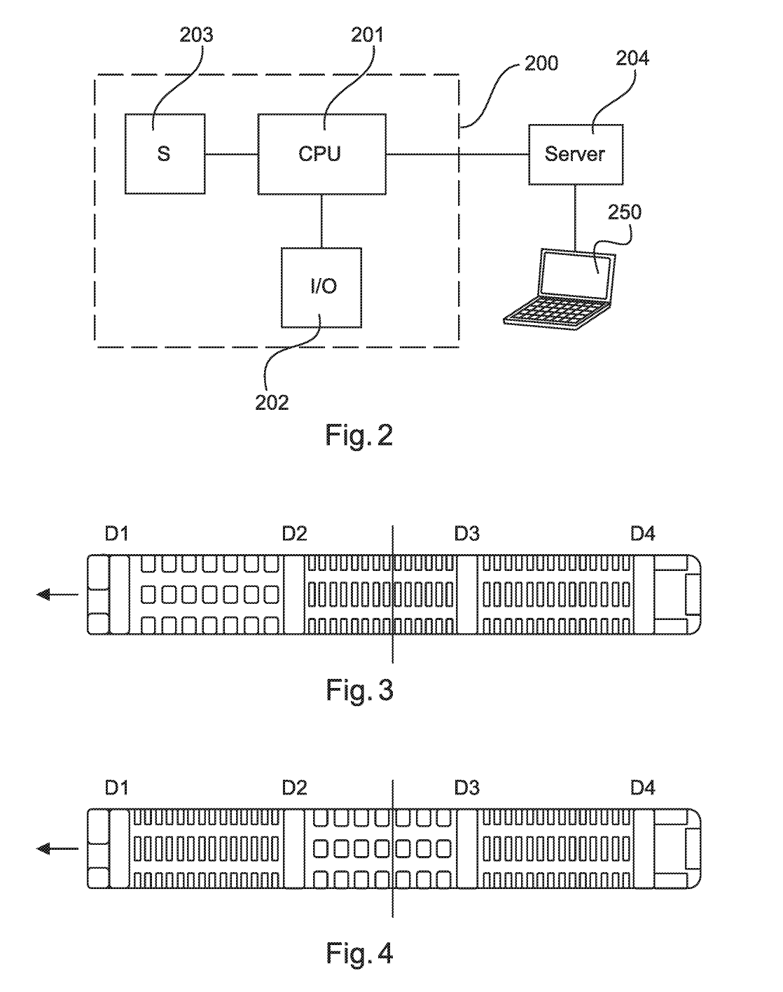

FIG. 2 show a booking device which may also be indicated as booking system, which booking device comprises an aircraft reconfigurator 200 or may at least have access thereto.

In particular, the aircraft reconfigurator 200 comprises a processing unit 201, a data storage 203 connected thereto, and an input/output unit 202. As a matter of course, multiple input/output units may be provided as well.

The processing unit 201 is connected to a server 204 which is likewise connected to an input/output unit 250. This input/output unit 250 may be used by passengers when booking seats, for example.

The system shown in FIG. 2 is able to modify the configuration, i.e., also the cabin layout, in a targeted manner as to improve the position of the center of gravity of the aircraft, i.e., to shift it towards the optimized position of the center of gravity. Thereby, the fuel consumption of the aircraft can be reduced.

The cabin layout may be automatically generated by using so-called key-performance-indicators, seat and cargo returns, and airline requirements as to obtain an optimized aircraft configuration. In particular, a description logic may be used therefor as to bring all elements of the aircraft logically in relation and to be able to assess rapidly and efficiently which elements and installation positions related thereto are possible and which are not.

The reconfigurator is able to determine the actual position of the center of gravity of the aircraft and to shift it in a direction towards an optimized position in a targeted manner. Thereby, the reconfigurator may consider the number of booked passengers per seat class, the position of the individual seats and possibly other installations of the passenger cabin, the number, individual and total weight of the cargo pieces to be carried along and possibly also the weight of the fuel and water to be carried along, and the reduction of the weight of the aircraft during the flight.

For example, the reconfigurator begins with a predetermined configuration of the aircraft which either already exists in this manner (aside from the loading) as the aircraft is already put into operation or which was generated prior to the actual assembly of the aircraft. The optimized position of the center of gravity is being determined from this existing airplane configuration and for a specific loading condition and a specific flight mission (long-distance/short-distance).

Now, the system may ensure that the actual center of gravity of the aircraft shifts toward the optimal center of gravity in case of a desired reconfiguration as to save fuel. In particular, the system may be configured to determine specific loading scenarios and to bring these to the carrier's attention such that the carrier can decide in a qualified manner at which positions to advantageously position specific cargo pieces. FIGS. 3 and 4 show possible positions of elements in an aircraft cabin which may be described and linked with each other by means of a description logic, for example.

As now possible positions of various cabin installations as seats, baggage compartments, lavatory modules and galleys are being linked with each other, it is possible that the reconfigurator shifts or swaps specific positions as to come to a better position of the center of gravity.

For example, if the position of the center of gravity shall be shifted towards the nose, it is possible to shift a business class seat zone which is arranged in a front region of the aircraft cabin from the region between door 1 and door 2 in the region between door 2 and 3 tailwards. Subsequently, a light lavatory module can be shifted further tailwards and a heavy weight galley can be shifted further towards the nose, for example to the position where the light lavatory module was positioned previously. In total, additional galley capacity can be shifted towards the nose.

In case the position of the center of gravity shall be shifted further tailwards, the following steps may be executed:

1. Avoiding heavy weight galleys in the region of door 1.

2. Arranging heavy weight front galleys in the region of the wing box (in case this is being classified useful by the reconfigurator) and/or using a heavier tail galley.

3. Light lavatory modules may be shifted further towards the nose.

Description logic may be used as to obtain suitable layouts of the cabin in an efficient manner. In case the cabin layout and the entire configuration of the aircraft are already fixed, the reconfigurator may be used to place the booked passengers to suitable seats and to suitably arrange the carried baggage and other cargo pieces in the cargo space so that the position of the center of gravity can be optimized.

FIG. 3 shows possible positions of elements of an aircraft, which positions were determined by using the aircraft reconfigurator.

FIG. 4 shows other possible positions of elements of the aircraft of FIG. 3. In comparison to FIG. 3, an economy class (EC) seat zone is interchanged with a business class (BC) seat zone so that the center of gravity is relocated further to the tail.

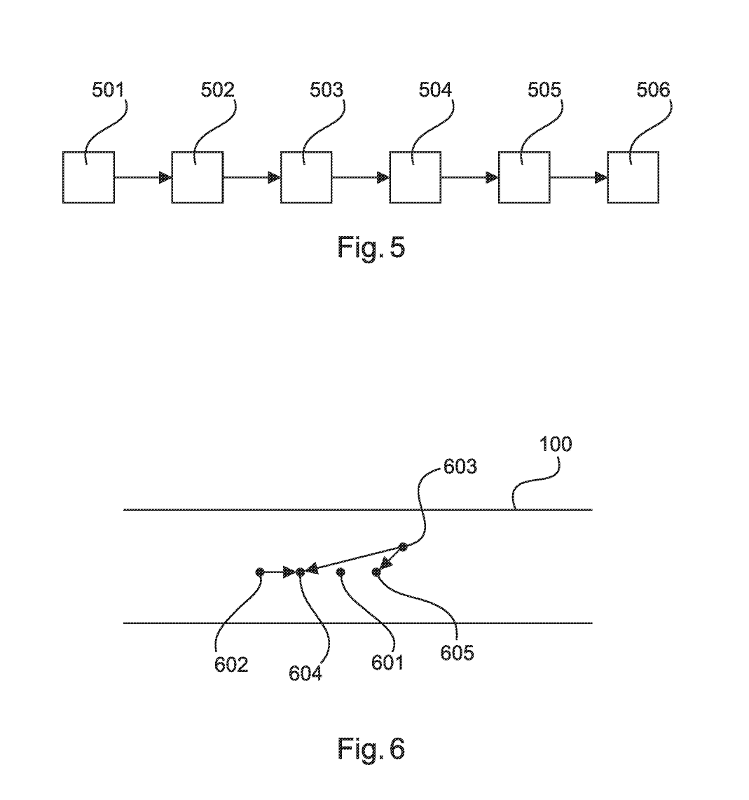

FIG. 5 shows a flow chart of a method according to an exemplary embodiment of the invention. In step 501, determination of an optimized position of the center of gravity of an aircraft takes place for a given total weight of the aircraft. In step 502, determination of the position of the actual center of gravity takes place for a predetermined configuration, seat allocation, and cargo loading. In step 503, one or multiple elements of the aircraft are (virtually) shifted as to shift the position of the actual center of gravity in a direction towards the optimal position of the center of gravity. In step 504, a new aircraft configuration is determined for which the corresponding elements are shifted, and in step 505 it is determined how much fuel can be saved due to this reconfiguration. In case the operator enables the reconfiguration, it is actually carried out in step 506.

FIG. 6 shows an optimized position 601 of the center of gravity of an aircraft, and two examples for actual positions of the center of gravity 602, 603 determined by the reconfigurator. In the first case, the center of gravity 602 is too near to the nose but at least along the longitudinal axis of the aircraft, and in the second case, the center of gravity 603 is too near to the tail.

Due to the shifting of in particular heavy weight installations, it is possible to shift the center of gravity 602 further to the tail to the position 604. If the center of gravity of the aircraft is actually located at the position 603, it is possible to shift the center of gravity a bit closer to the nose and to the left to position 605 or even considerably farther towards the nose and to the left to the position 604 by shifting specific elements of the aircraft.

Optimally and as a matter of course, the center of gravity is shifted exactly to the position 601 as this is that position of the center of gravity for which under a given loading condition most fuel may be saved.

Additionally, it is noted that “including” and “comprising” does not exclude any other elements and “a” or “an” does not exclude a plurality. It is further noted that features or steps which are described with reference to one of the above exemplary embodiments may also be used in combination with other features or steps of other exemplary embodiments described above. Reference signs in the claims are not to be construed as a limitation.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. An aircraft reconfigurator system to reconfigure a predetermined aircraft configuration, the aircraft reconfigurator system comprising:
a processing unit that executes software program instructions to:
determine a distance between a position of the center of gravity of the aircraft which center of gravity is optimized with regard to aerodynamic aspects and the actual position of the center of gravity;
select an element of the aircraft and determining its position;
determine a new position of the element of the aircraft as to approximate the position of the center of gravity to the optimized position; and
determine a new aircraft configuration, in which the selected element is arranged in the new position.

2. The aircraft reconfigurator system according to claim 1, further comprising an input unit for predetermining loading data of the aircraft, which loading data reflect the weight and the kind of cargo pieces to be transported, wherein the processing unit is configured to consider the cargo pieces as elements of the aircraft, and to determine the actual position of the center of gravity in consideration of the loading data.

3. The aircraft reconfigurator system according to claim 1, further comprising an input unit for predetermining passenger data of the aircraft, wherein the passenger data reflects the number of passengers to be transported, and wherein the processing unit is configured to consider the passengers as elements of the aircraft and to determine the actual position of the center of gravity in consideration of the passenger data.

4. The aircraft reconfigurator system according to claim 1, wherein the element is a monument of an aircraft cabin comprising a galley or a lavatory module, a system component, a particularly electric consumer, a passenger seat, or a structural component.

5. The aircraft reconfigurator system according to claim 1, wherein the element is a trolley.

6. The aircraft reconfigurator system according to claim 1, further comprising an input unit for changing the new position of the element of the aircraft after the processing unit has determined the new aircraft configuration, wherein the processing unit is configured to select a further element of the aircraft thereupon and to subsequently determine a new position of the further element in order to approximate the position of the center of gravity to the optimized position.

7. The aircraft reconfigurator system according to claim 1, wherein the processing unit is configured to determine a probable average fuel saving related to the new position of the element of the aircraft, and related to the new aircraft configuration.

8. A booking system for an airline, the booking system comprising:
an aircraft reconfigurator system comprising a processing unit configured to:
determine a distance between a position of the center of gravity of the aircraft which center of gravity is optimized with regard to aerodynamic aspects and the actual position of the center of gravity;
select an element of the aircraft and determining its position;
determine a new position of the element of the aircraft as to approximate the position of the center of gravity to the optimized position; and
determine a new aircraft configuration, in which the selected element is arranged in the new position.

9. A method of reconfiguring a predetermined aircraft configuration, the method comprising the steps of:
determining a distance between a position of the center of gravity of the aircraft which center of gravity is optimized with regard to aerodynamic aspects and the actual position of the center of gravity;
selecting an element of the aircraft;
determining a new position of the element of the aircraft as to approximate the position of the center of gravity to the optimized position; and
determining a new aircraft configuration, in which the selected element is arranged in the new position.

10. A computer readable medium, having a program stored thereon that instructs a processor of a processing unit to carry out the following steps when being carried out on the processor:
determining a distance between a position of the center of gravity of the aircraft which center of gravity is optimized with regard to aerodynamic aspects and the actual position of the center of gravity;
selecting an element of the aircraft;
determining a new position of the element of the aircraft as to approximate the position of the center of gravity to the optimized position; and
determining a new aircraft configuration, in which the selected element is arranged in the new position.
